(19) United States
(12) Patent Application Publication
(10) Pub. No.: US 2026/0331971 A1
(43) Pub. Date: Oct. 22, 2026

(54) SELF-CENTERING ELECTRIC ROTARY TORQUE MOTOR

(71) Applicant: Moog Inc., East Aurora, NY (US)

(72) Inventor: Robert P. Gerbetz, Waukegan, IL (US)

(21) Appl. No.: 19/122,837

(22) PCT Filed: Oct. 18, 2023
(86) PCT No.: PCT/US2023/077126

§ 371 Date: Apr. 21, 2025

Related U.S. Application Data
(60) Provisional application No. 63/380,641, filed on Oct. 24, 2022.

(51) Int. Cl. H02K 1/16; F16K 31/04; H02K 1/278

(52) U.S. Cl. CPC H02K 1/165; F16K 31/041; H02K 1/278; H02K 2201/03

(57) ABSTRACT

An electric rotary torque motor, including a stator, including a yoke, a plurality of teeth extending radially inward from the yoke and separated circumferentially by slots, the plurality of teeth forming a radially inward facing surface, and electrical windings arranged in one or more of the slots, a rotor operatively arranged to rotate from a null angular position to an off-null angular position, the rotor including a radially outward facing surface and at least one permanent magnet, and a radial airgap arranged between the radially outward facing surface of the rotor and the radially inward facing surface of the stator, the radial airgap varying in radial depth about the center axis and having a minimum radial depth at the null angular position and a greater radial depth at the off-null angular position, wherein the rotor is biased to the null angular position.

### CROSS-REFERENCE TO RELATED APPLICATIONS

This application claims the benefit under Articles 4 and 8 of the Stockholm Act of the Paris Convention for the Protection of Industrial Property of U.S. Patent Application No. 63/380,641, filed on Oct. 24, 2022, which application is incorporated herein by reference in its entirety.

### TECHNICAL FIELD

The present disclosure relates generally to electric rotary motors, and more particularly, to a self-centering torque motor.

### BACKGROUND ART

An electric motor converts electrical energy into mechanical rotational power. Most electric motors operate through the interaction between a stator magnetic field and a rotor magnetic field to generate force within the motor. Rotating motors ordinarily include a stationary component known as a stator and a rotating component known as a rotor. Adjacent faces of the rotor and stator are separated by a small air gap traversed by magnetic flux linking the rotor and stator. A radial airgap type motor is one in which the rotor and stator are separated radially by an air gap and the traversing magnetic flux is directed predominantly perpendicular to the axis of rotation of the rotor. Thus, a radial flux motor has flux running radially in and out from the center of the rotor or shaft.

However, current radial airgap motor designs to not have a self-centering feature to bias the rotor back to a start position. Additionally, current biasing elements for motors are bulky and require additional componentry to achieve such biasing effect.

### BRIEF SUMMARY

With parenthetical reference to corresponding parts, portions or surfaces of the disclosed embodiment, merely for the purposes of illustration and not by way of limitation, the present disclosure provides an electric rotary torque motor (10), comprising a stator (20), including a yoke (22), a plurality of teeth (24) extending radially inward from the yoke (22) and separated circumferentially by slots (26), the plurality of teeth (24) forming a radially inward facing surface (28), and electrical windings (31, 33, 35) arranged in one or more of the slots (26), a rotor (40) operatively arranged to rotate about a center axis (AX) relative to the stator (20) from a null angular position (L1) to an off-null angular position (L2), the rotor (40) including a radially outward facing surface (42) and at least one permanent magnet (44, 46), and a radial airgap (50) arranged between the radially outward facing surface (42) of the rotor (40) and the radially inward facing surface (28) of the stator (20), the radial airgap (50) varying in radial depth about the center axis (AX) and having a minimum radial depth (52) at the null angular position (L1) and a greater radial depth (54) at the off-null position (L2), wherein the at least one permanent magnet (44, 46) is positioned circumferentially on the rotor (40) such that when the electrical windings (31, 33, 35) are de-energized the rotor (40) is biased to the null angular position (L1).

The rotor (40) may be in the null position (L1) when the at least one magnet (44, 46) is aligned with the minimum radial depth (52). When the electrical windings (31, 33, 35) are energized the rotor (40) may displace circumferentially with respect to the stator (20) such that the at least one magnet (44, 46) is aligned with the off-null position (L2). The greater radial depth (54) at the off-null position (L2) may be the maximum radial depth. The radially inward facing surface (28) may be non-cylindrical. The radially inward facing surface (28) may be an ellipse. The radially inward facing surface (28) may be an oval. The plurality of teeth (24) may comprise coils (30, 32, 34) and the coils (30, 32, 34) are connected to form the electrical windings (31, 33, 35). The off-null position (L2) may be ±45° from the null position (L1). The rotor (40) may be operatively arranged to displace only +45° from the null position (L1). The rotor (40) may be operatively arranged to open and close a valve.

With parenthetical reference to corresponding parts, portions or surfaces of the disclosed embodiment, merely for the purposes of illustration and not by way of limitation, the present disclosure provides an electric rotary torque motor (10), comprising a stator (20), including a yoke (22), a plurality of teeth (24) extending radially inward from the yoke (22) and spaced apart by slots (26), the plurality of teeth (24) forming a non-cylindrical radially inward facing surface (28), and a plurality of electrical windings (31, 33, 35) engaged with at least two of the plurality of teeth (24), a rotor (40) arranged in the stator (20) and including a radially outward facing surface (42) and at least one permanent magnet (44, 46), and a radial airgap (50) arranged between the radially outward facing surface (42) and the radially inward facing surface (28), the radial airgap (50) varying in radial depth and having a minimum radial depth (52) at a first angular position (L1) and a maximum radial depth (54, 56) at a second angular position (L2, L3), wherein the rotor (40) is in a null position when the at least one permanent magnet (44, 46) is aligned with the first angular position (L1), and the rotor (40) is biased toward the null position (L1).

When the plurality of electrical windings (314, 33, 35) are energized the rotor (40) may be displaced from the null position (L1) toward the second angular position (L2, L3). When the plurality of electrical windings (31, 33, 35) are de-energized the rotor (40) may be biased toward the null position (L1). The radially inward facing surface (28) may be an ellipse. The radially inward facing surface (28) may be an oval. The second angular position (L2) may be 45° from the null position (L1). The rotor (40) may be operatively arranged to displace only ±45° from the null position (L1). The rotor (40) is operatively arranged to open and close a valve.

With parenthetical reference to corresponding parts, portions or surfaces of the disclosed embodiment, merely for the purposes of illustration and not by way of limitation, the present disclosure provides an electric rotary torque motor (10), comprising a stator (20), including a yoke (22), a plurality of teeth (24) extending radially inward from the yoke (22) and spaced apart by slots (26), the plurality of teeth (24) forming a stator bore comprising a non-cylindrical radially inward facing surface (28), and at least one electrical winding (31, 33, 35) arranged in one or more of the slots (26), a rotor (40) rotatably arranged in the bore, the rotor (40) including a cylindrical shaft comprising a radially outward facing surface (42) and a plurality of permanent magnets (44, 46), and a radial airgap (50) arranged between the radially outward facing surface (42) and the radially inward facing surface (28), the radial airgap (50) at a first angular position (L1) is a first distance (52) and the radial airgap (50) at a second angular position (L2, L3) is a second distance (54, 56), the second distance (54, 56) being greater than the first distance (52), wherein the rotor (40) is in a null position (L1) when the plurality of permanent magnets (44, 46) are aligned with the first angular position (L1), and the rotor (40) is biased toward the null position (L1).

The following will describe embodiments of the present disclosure, but it should be appreciated that the present disclosure is not limited to the described embodiments and various modifications of the disclosure are possible without departing from the basic principles. The scope of the present disclosure is therefore to be determined solely by the appended claims.

### BRIEF DESCRIPTION OF THE DRAWINGS

Various embodiments are disclosed, by way of example only, with reference to the accompanying schematic drawings below in which corresponding reference symbols indicate corresponding parts.

FIG. 1 is an elevational view of a self-centering torque motor.

FIG. 2 is an enlarged view of a portion of the self-centering torque motor shown in FIG. 1.

FIG. 3 is a graph showing attributes of the self-centering torque motor shown in FIG. 1.

### DETAILED DESCRIPTION OF THE EMBODIMENTS

At the outset, it should be clearly understood that like reference numerals are intended to identify the same structural elements, portions, or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal,” “vertical,” “left,” “right,” “up” and “down,” as well as adjectival and adverbial derivatives thereof (e.g., “horizontally,” “rightwardly,” “upwardly,” etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices, or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element. A similar interpretation is intended when the phrase “used in at least one of:” is used herein.

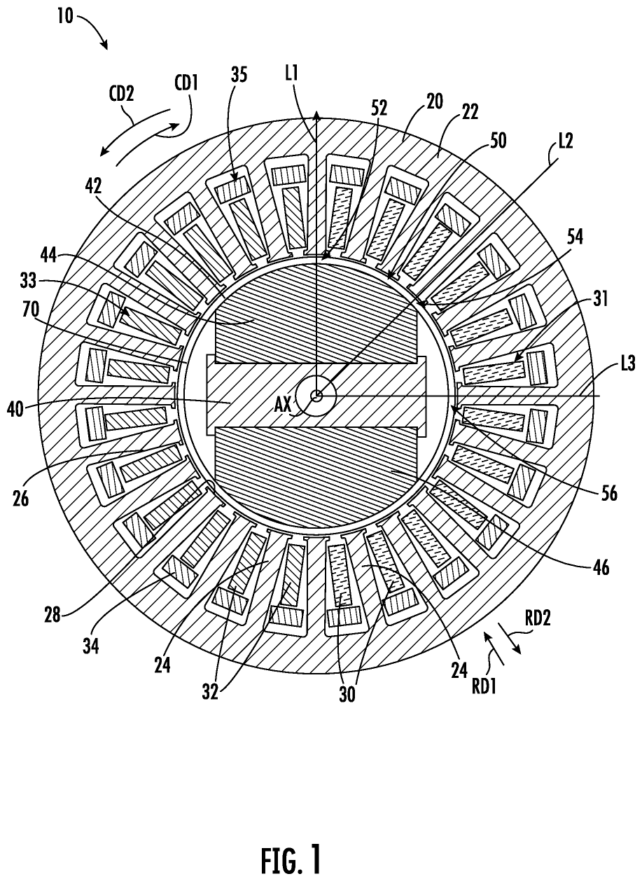

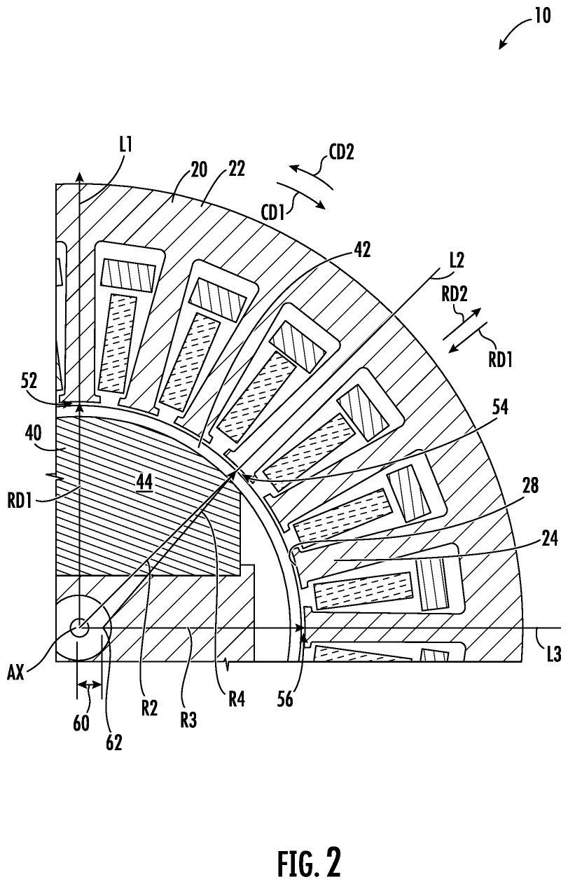

Adverting now to the figures, FIG. 1 is an elevational view of self-centering torque motor 10. FIG. 2 is an enlarged view of a portion of self-centering torque motor 10. Self-centering torque motor or torque motor 10 is an electric rotary torque motor that has a self-centering configuration. Torque motor 10 generally comprises stator 20 and rotor 40.

Stator 20 is generally cylindrical and comprises yoke 22 and a plurality of teeth 24 extending radially inward in radial direction RD2 from yoke 22. Teeth 24 are spaced circumferentially to form slots 26. Each of teeth 24 comprises radially inward facing surface 28. Stator 20 further comprises electrical windings or coils. For example, stator 20 comprises coils 30, 32, 34 wrapped or engaged with teeth 28. Each of coils 30, 32, and 34 comprises a plurality of wire turns.

In some embodiments, coils 30, 32, 34 comprise 62/31 turns per coil. 62/31 represents the number of turns of wire in each slot. For example, in some embodiments two windings are wound in twelve slots, one of the windings on the left hand side and the other winding on the right hand side. Each of those windings has six coils and each coil has sixty-two turns. A third winding is wound in all twenty-four slots, has twelve coils and thirty-one turns in each coil. The total number of turns in each winding is the same.

Coils 30, 32, 34 may be selectively connected to form windings. For example, coils 30 are arranged on the right side of line L1 in FIG. 1, and are interconnected to form windings 31. Coils 32 are arranged on the left side of line L1 in FIG. 1, and are interconnected to form windings 33. Coils 34 are all connected to form windings 35. In some embodiments, coils 30, 32, 34 are arranged in and/or engaged with slots 26. In some embodiments, 25.5 American Wire Gauge (AWG) HML wire is used for coils 30, 32, 34. In some embodiments, each winding exhibits 7.73 ohms of resistance at 25 °C. It should be appreciated that stator 20 may comprises a plurality of stator laminations. In some embodiments, the stator lamination stack length of stator 20 is approximately 1.05 inches. In some embodiments, stator 20, coils 30, 32, 34, and/or windings 31, 33, 35 comprise insulation.

It should be appreciated that stator 20 may comprise various stator types, including but not limited to, distributed, concentrated, and toroidal wound stators. It should further be appreciated that magnets 44, 46 may comprise bread loaf, arc, or other magnet shapes and magnet orientations. In some embodiments, motor 10 comprises a two-pole distributed winding stator. In some embodiments, motor 10 comprises a four-pole concentrated winding stator. In some embodiments, the four-pole concentrated winding version of motor 10 can be built in a square housing to save space, wherein the poles and the housing can be separate parts. The housing can have a number of sides (e.g., 4, 6, etc.) corresponding to the number of poles wherein the poles are connected to the housing with the coils' insulation. In such embodiments, the poles and the housing form the stator.

Rotor 40 is arranged in and rotates with respect to stator 20. Rotor 40 is cylindrical and comprises radially outward facing surface 42, and one or more magnets, for example, magnet 44 and magnet 46. In some embodiments, magnets 44 and 46 are arranged on rotor 40 diametrically opposed from each other, namely, 180 degrees from each. In some embodiments, magnets 44 and 46 are permanent magnets. Rotor 40 may further comprise or be connected to a shaft. In some embodiments, rotor 40 is connected to a valve (e.g., a single stage valve), for example via a shaft. In some embodiments, rotor 40 is connected to a direct drive valve (DDV), for example, a MOOG® direct drive analog control servo valve. In such embodiments, motor 10 is the driver for the DDV or other valve.

Rotor 40 rotates relative to stator 20 due to magnetic forces generated by windings 31, 33, 35 when energized. When windings 31, 32, 35 are energized, a magnetic field is formed that interacts with the magnetic field of magnets or poles 44 and 46 such that torque and subsequent rotation is produced in rotor 40 relative to stator 20. In some embodiments, rotor 40 is arranged in stator 20 and held in place by endplates and bearings. Radially outward facing surface 42 and radially inward facing surfaces 28 of teeth 24 are separated by radial airgap 50. Magnetic flux traverses radial airgap 50 linking rotor 40 to stator 20 such that when current is appropriately applied through windings 31, 32, 35 of stator 20 a magnetic field is induced. Thus, a radial flux-traversing airgap 50 is provided between radially outward facing surface 42 of rotor 40 and radially inward facing surface 28 of stator 20.

As shown in FIG. 1, line L1 represents an angular position of 0°, line L2 represents an angular position of 45° from line L1 in circumferential direction CD1, and line L3 represents an angular position of 90° from line L1 in circumferential direction CD1. The distance from axis AX to radially inward facing surface 28 of the tooth 24 aligned with line L1 is represented by radius R1. The distance from axis AX to radially inward facing surface 28 of the tooth 24 aligned with line L2 is represented by radius R2. The distance from axis AX to radially inward facing surface 28 of the tooth 24 aligned with line L3 is represented by radius R3. Radius R2 is greater than radius R1. In some embodiments, radius R3 is greater than radius R2. As such, radial airgap 50 varies in a circumferential direction. For example, radial airgap 52 represents the radial distance between radially outward facing surface 42 and radially inward facing surface 28 along line L1. Radial airgap 54 represents the radial distance between radially outward facing surface 42 and radially inward facing surface 28 along line L2. Radial airgap 56 represents the radial distance between radially outward facing surface 42 and radially inward facing surface 28 along line L3. Radial airgap 54 is greater than radial airgap 52. In some embodiments, radial airgap 56 is greater than radial airgap 54.

In some embodiments, radius R3 is equal to radius R1. In such embodiments, radial airgap 52 is equal to radial airgap 56. Radial airgap 50 increases in circumferential direction CD1 from line L1 (i.e., null angular position) to line L2. Likewise, radial airgap 50 increases in circumferential direction CD2 from line L3 to line L2. For example, offset 60 can be used to increase radius R2, while radially inward facing surfaces 28 remain symmetrical on both circumferential sides of line L2.

Radially inward facing surfaces 28 of teeth 24 form a non-circular geometric shape wherein radial airgap 50 increases in a circumferential direction. For example, in some embodiments, radially inward facing surfaces 28 form an ellipsoid having a major axis, along line L3, and a minor axis, along line L1. In some embodiments, radially inward facing surfaces 28 form an oval. As a result, the radial airgap between radially outward facing surface 40 and radially inward facing surfaces 28 varies circumferentially about axis AX of rotor 40 and is not constant.

Rotor 40 is in a null position when magnets 44, 46 are aligned with the smallest radial airgap, for example radial airgap 52 along line L1. Thus, FIG. 1 shows torque motor 10 in the null position (i.e., magnets 44 and 46 are aligned with line L1 and radial airgap 52). Rotor 40 is biased toward the null position by the variable radial airgap 50. This is referred to as centering or biasing torque (i.e., torque imparted on rotor 40 to return rotor 40 back to alignment with the smallest radial airgap 52). Specifically, rotor 40 is biased toward the null position because magnets 44 and 46 are biased toward a state of maximum stored energy, which is when air gap 50 is smallest. The total flux linking the magnets is higher when the gap between magnets 44, 46 and stator 20 is smaller, and so the stored energy is higher. Force and torque are proportional to the change in stored energy divided by distance or angle moved during the change in stored energy. The work that's done to move the magnets away from the null or rest position becomes potential energy. Because the effective current excitation in a permanent magnet is so large, the small change in flux caused by the small change in air gap results in a relatively large change in energy. But this small change in flux has very little effect on the torque produced by the torque motor stator windings when compared to the torque produced by the windings in a torque motor with a constant radial air gap. The torque produced by the windings is proportional to magnet produced flux, and the change in flux between a stator with a constant air gap and a stator with a variable air gap is very small, on the order of 1%. Thus, electrical windings 31, 32, 35 are energized thereby rotating rotor 40 with respect to stator 20, for example about 45 degrees in circumferential direction CD1. When the power to electrical windings 31, 32, 35 is cut, rotor 40 is biased back to the null position due to the tendency of magnets 44, 46 to reside in a position of smallest radial airgap. In some embodiments, motor 10 is a limited angle torque motor having a null position and an angular range of ±45° from the null position.

As best shown FIG. 2, instead of requiring a separate centering device, motor 10 comprises radial offset 60 to the inner diameter of stator 20 on opposite sides of line L1 (e.g., ±45° from the null position), which creates a desired centering torque on rotor 40 to its null position. As previously described, magnets 44, 46 are drawn to alignment with the smallest radial airgap, or the null position. The result of radial offset 60 is radial airgap 54 being greater than radial airgap 52. For example, radius R1 is equal to radius R4; however, radius R1 is measured from axis AX whereas radius R4 is measured from point P, which is offset from axis AX by distance 60 along line L3, line L3 being perpendicular to line L1. In some embodiments, offset 60 is 0.375 mm. It should be appreciated that, in some embodiments, radial airgap 50 is smallest at the null position, namely, radial airgap 52, and increases as a function of angular displacement away from the null position in either circumferential direction CD1 or circumferential direction CD2. This variation in radial airgap 50 provides a centering torque on rotor 40 toward the null position.

In some embodiments, and as shown in FIG. 1, self-centering torque motor 10 further comprises tube 70 arranged radially between stator 20 and rotor 40. Tube 70 isolates hydraulic fluid from stator 20. In some embodiments, tube 70 comprises beryllium copper. FIG. 2 shows self-centering toque motor 10 without tube 70 to better illustrate radial airgap 50.

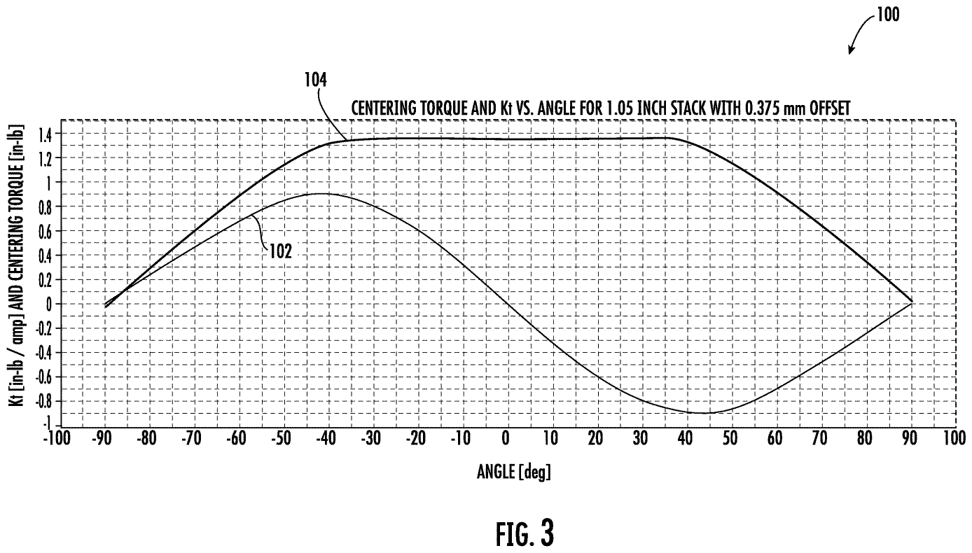

FIG. 3 shows graph 100 showing attributes of self-centering torque motor 10. The centering or biasing torque vs. angle is indicated by line 102 and the torque constant Kt is indicated by line 104. The measurements shown in graph 100 were taken using a 1.05 inch stack of laminated stators 20 with a 0.375 mm offset. Furthermore, damping coefficient B is equal to 0.20 inch-pounds/(radians/second). Damping coefficient B defines a speed dependent torque opposing rotation and generated by losses in the magnetic material, laminations. As shown, when magnets 44 and 46 are positioned at +90° (indicated by line L1), rotor 40 is in the null position and the centering torque is 0 inch-pounds. As rotor 40 is displaced in circumferential direction CD1 or circumferential direction CD2, the centering torque increases. The centering torque is at a maximum when magnets 44 and 46 are positioned at ±45° (indicated by line L2). For example, when magnets 44 and 46 are positioned at −45° the centering torque is 0.9 inch-pounds in circumferential direction CD1, back to the null position. When magnets 44 and 46 are positioned at +45° the centering torque is 0.9 inch-pounds in circumferential direction CD2, back to the null position. The torque constant Kt is variable on which torque is measured. Torque is equal to current x torque constant. Torque in the motor is generated by exciting any of the windings and the torque produced is equal to current x torque constant. The current can be positive or negative and the resulting torque can be positive or negative. Total torque is equal to (torque constant Kt x current) +centering torque. The variable radial airgap 50, namely, larger radial airgap 54 created by offset 60, has no effect on torque constant Kt, as indicated by line 104 in graph 100.

The improved electric motor assembly 10 provides a number of advantages over the prior art. Such advantages include a self-centering rotor 40 without the need for a separate centering device or additional components, and as such, a smaller overall size.

The present invention contemplates that many changes and modifications may be made. The diameter size of the components is scalable, depending on the performance desired from the final motor. The length of the assembled motor, the axial thickness of the pole sections, and the number of pole sections are scalable, again depending on the performance desired and the practical manufacturing limits of the components. Therefore, while the presently preferred form of the motor assembly has been shown and described, those persons skilled in this art will readily appreciate the various additional changes and modification may be made without departing from the spirit of the invention, as defined and differentiated by the following claims.

This disclosure has been described in detail with particular reference to an embodiment, but it will be understood that variations and modifications can be effected within the spirit and scope of the disclosure. The presently disclosed embodiments are therefore considered in all respects to be illustrative and not restrictive. The scope of the disclosure is indicated by the appended claims, and all changes that come within the meaning and range of equivalents thereof are intended to be embraced therein.

1. An electric rotary torque motor, comprising:
a stator, including:
a yoke;
a plurality of teeth extending radially inward from the yoke and separated circumferentially by slots, the plurality of teeth forming a radially inward facing surface; and
electrical windings arranged in one or more of the slots;
a rotor operatively arranged to rotate about a center axis relative to the stator from a null angular position to an off-null angular position, the rotor including a radially outward facing surface and at least one permanent magnet; and
a radial airgap arranged between the radially outward facing surface of the rotor and the radially inward facing surface of the stator, the radial airgap varying in radial depth about the center axis and having a minimum radial depth at the null angular position and a greater radial depth at the off-null angular position;
wherein the at least one permanent magnet is positioned circumferentially on the rotor such that when the electrical windings are de-energized the rotor is biased to the null angular position.

2. The electric rotary torque motor as recited in claim 1, wherein the rotor is in the null position when the at least one magnet is aligned with the minimum radial depth.

3. The electric rotary torque motor as recited in claim 1, wherein when the electrical windings are energized the rotor displaces circumferentially with respect to the stator such that the at least one magnet is aligned with the off-null angular position.

4. The electric rotary torque motor as recited in claim 1, wherein the greater radial depth at the off-null angular position is the maximum radial depth.

5. The electric rotary torque motor as recited in claim 1, wherein the radially inward facing surface is non-cylindrical.

6. The electric rotary torque motor as recited in claim 1, wherein the radially inward facing surface is an ellipse.

7. The electric rotary torque motor as recited in claim 1, wherein the radially inward facing surface is an oval.

8. The electric rotary torque motor as recited in claim 1, wherein the plurality of teeth comprise coils and the coils are connected to form the electrical windings.

9. The electric rotary torque motor as recited in claim 1, wherein the off-null angular position is ±45° from the null position.

10. The electric rotary torque motor as recited in claim 1, wherein the rotor is operatively arranged to displace only +45° from the null position.

11. The electric rotary torque motor as recited in claim 1, wherein the rotor is operatively arranged to open and close a valve.

12. An electric rotary torque motor, comprising:
a stator, including:
a yoke;
a plurality of teeth extending radially inward from the yoke and spaced apart by slots, the plurality of teeth forming a non-cylindrical radially inward facing surface; and
a plurality of electrical windings engaged with at least two of the plurality of teeth;
a rotor arranged in the stator and including a radially outward facing surface and at least one permanent magnet; and
a radial airgap arranged between the radially outward facing surface and the radially inward facing surface, the radial airgap varying in radial depth and having a minimum radial depth at a first angular position and a maximum radial depth at a second angular position;
wherein:
the rotor is in a null position when the at least one permanent magnet is aligned with the first angular position; and
the rotor is biased toward the null position.

13. The electric rotary torque motor as recited in claim 12, wherein when the plurality of electrical windings are energized the rotor is displaced from the null position toward the second angular position.

14. The electric rotary torque motor as recited in claim 12, wherein when the plurality of electrical windings are de-energized the rotor is biased toward the null position.

15. The electric rotary torque motor as recited in claim 12, wherein the radially inward facing surface is an ellipse.

16. The electric rotary torque motor as recited in claim 12, wherein the radially inward facing surface is an oval.

17. The electric rotary torque motor as recited in claim 12, wherein the second angular position is 45° from the null position.

18. The electric rotary torque motor as recited in claim 12, wherein the rotor is operatively arranged to displace only +45° from the null position.

19. The electric rotary torque motor as recited in claim 12, wherein the rotor is operatively arranged to open and close a valve.

20. An electric rotary torque motor, comprising:
a stator, including:
a yoke;
a plurality of teeth extending radially inward from the yoke and spaced apart by slots, the plurality of teeth forming a stator bore comprising a non-cylindrical radially inward facing surface; and
at least one electrical winding arranged in one or more of the slots;
a rotor rotatably arranged in the bore, the rotor including a cylindrical shaft comprising a radially outward facing surface and a plurality of permanent magnets; and
a radial airgap arranged between the radially outward facing surface and the radially inward facing surface, the radial airgap at a first angular position is a first distance and the radial airgap at a second angular position is a second distance, the second distance being greater than the first distance;
wherein:
the rotor is in a null position when the plurality of permanent magnets are aligned with the first angular position; and
the rotor is biased toward the null position.
